(19) United States
(12) Patent Application Publication
(10) Pub. No.: US 2026/0231907 A1
(43) Pub. Date: Aug. 13, 2026

(54) ANIMAL COLLAR WITH A CONNECTOR

(71) Applicant: Radio Systems Corporation, Knoxville, TN (US)

(72) Inventor: Charles Joseph IVINS, Knoxville, TN (US)

(21) Appl. No.: 19/047,947

(22) Filed: Feb. 7, 2025

(51) Int. Cl. A01K 27/00

(52) U.S. Cl. CPC A01K 27/001; A01K 27/009

(57) ABSTRACT

The present disclosure describes to an animal collar that includes a novel connection mechanism. In an example, an animal collar includes an electronics module including a housing. The housing includes a first pin extending along a first side and a second pin extending along a second side. The animal collar further includes a strap portion having a first flexible section and a second flexible section. The animal collar further includes a first j-hook fixedly attached at an opposite end of the first flexible section from a buckle and a second j-hook fixedly attached at an opposite end of the second flexible section from the buckle. The first j-hook and the second j-hook each are constructed from a resilient material and have an opening and a central aperture.

### BACKGROUND

Animals wear collars for many purposes. For example, tags can be attached to the collar so animal ownership information can be easily found. Further, collars may include an electronics module. These electronic modules may perform various programmed functions. Some examples include providing feedback to the animal wearing the collar based on certain conditions. The conditions can include approaching a boundary, or when the animal barks. In some cases, the feedback is used for training the animal.

Electronics module that are included in an animal collar are typically packaged into a modular housing, and may be attached to the animal collar in a secure manner to ensure that they are retained when worn by an animal. Animal owners often wish to choose a customized collar color, style, or appearance of a collar strap while utilizing a common, modular housing. As such, for aesthetic reasons, an animal owner may wish to conveniently substitute a different collar strap for use with the same electronics housing used in an animal collar.

Furthermore, electronic modules consume energy to perform their respective functions. Thus, the electronics module may also include a battery that supplies necessary power. Once fully drained, the battery may need to be replaced or recharged so the electronic modules can continue to perform the programmed functions. In addition, the electronic modules may need to be removed to examine in closer detail and/or repair.

Accordingly, for a variety of reasons, animal collars are often attached and removed from an animal, and in some instances, portions of an animal collar may be desired to be removed from the collar overall (e.g., by detachment of the electronics module from other portions of a collar).

### SUMMARY

In accordance with the present disclosure, the above and other issues are addressed by the following:

In a first aspect, an animal collar includes an electronics module including a housing having a first side end and an opposed second side end. The housing includes a first pin extending along the first side and a second pin extending along the second side. The first pin and the second pin are each cylindrical-shaped and have a diameter. The animal collar further includes a strap portion having a first flexible section and a second flexible section. The first flexible section and the second flexible section are attachable to each other at a buckle. The animal collar further includes a first j-hook fixedly attached at an opposite end of the first flexible section from the buckle and a second j-hook fixedly attached at an opposite end of the second flexible section from the buckle. The first j-hook and the second j-hook each are constructed from a resilient material and have an opening and a central aperture. The opening leads to the central aperture. The central aperture has a diameter sized to accommodate the diameter of the first pin or the second pin, and the opening has a distance smaller than the diameter of the first pin or the second pin.

In a second aspect, a replacement strap for an animal collar includes a strap portion having a first flexible section and a second flexible section. The first flexible section and the second flexible section are attachable to each other at a buckle. The replacement strap further includes a j-hook fixedly attached at an opposite end of the first flexible section from the buckle. The j-hook is constructed from a resilient material and has an opening and a central aperture. The opening leads to the central aperture. The central aperture of the j-hook has a diameter sized to accommodate a cylindrical pin of a housing to which the replacement strap is attachable, and the opening has a distance smaller than the diameter of the cylindrical pin.

In a third aspect, an animal collar includes a component having a first side end and an opposed second side end. The component includes a first pin extending along the first side and a second pin extending along the second side. The first pin and the second pin are each cylindrical-shaped and having a diameter. The animal collar further includes a strap portion having a first flexible section and a second flexible section. The first flexible section and the second flexible section are attachable to each other at a buckle. The animal collar further includes a j-hook fixedly attached at an opposite end of the first flexible section from the buckle. The j-hook is constructed from a resilient material and has an opening and a central aperture. The opening leads to the central aperture. The central aperture of the j-hook has a diameter sized to accommodate the first pin to which the replacement strap is attachable, and the opening has a distance smaller than the diameter of the first pin.

### BRIEF DESCRIPTION OF THE DRAWINGS

Non-limiting and non-exhaustive examples are described with reference to the following figures.

FIG. 1 illustrates a first perspective view of an example animal collar.

FIG. 2 illustrates a second perspective view of the example animal collar of FIG. 1.

FIG. 3 illustrates a front view of the example animal collar of FIG. 1.

FIG. 4 illustrates a rear view of the example animal collar of FIG. 1.

FIG. 5 is a top view of the example animal collar of FIG. 1.

FIG. 6 is a bottom view of the example animal collar of FIG. 1.

FIG. 7 is a first side view of the example animal collar of FIG. 1.

FIG. 8 is a second side view of the example animal collar of FIG. 1.

FIG. 9 is a first exploded view of the example animal collar of FIG. 1.

FIG. 10 is a second exploded view of the example animal collar of FIG. 1.

FIG. 11 is a third exploded view of the example animal collar of FIG. 1.

FIG. 12 is a perspective view of an example connector of the example animal collar of FIG. 1.

FIG. 13 is a second perspective view of the example connector of the example animal collar of FIG. 1.

FIG. 14 is a side view of the example connector of the example animal collar of FIG. 1.

FIG. 15 is a side view of the example connector and an example pin.

FIG. 16 is a first view of an example disconnected connector of the example animal collar of FIG. 1.

FIG. 17 is a second view of the example disconnected connector of the example animal collar of FIG. 1.

FIG. 18 is a third view of an example disconnected connector of the example animal collar of FIG. 1.

FIG. 19 is a first cross-sectional view of the example connector of the example animal collar of FIG. 1.

FIG. 20 is a second cross-sectional view of the example connector of the example animal collar of FIG. 1.

### DETAILED DESCRIPTION

Various embodiments will be described in detail with reference to the drawings. Reference to various embodiments does not limit the scope of the claims attached hereto. Additionally, any examples set forth in this specification are not intended to be limiting and merely set forth some of the many possible embodiments.

As briefly described above, an animal collar typically includes a fastener that enables attachment of the animal collar to the animal. Example fasteners may include, e.g., a clasp, a snap fastener, or a buckle clip. Portions of the fastener can be snapped together, thereby attaching the collar to the animal. The animal collar can be removed by detaching the joined portions of the fastener.

While the fastener allows for easier removal of the collar from the animal, those animal collars that include an electronics module (retained within an electronics housing) may have separate attachment mechanisms for retaining the electronics module to the strap. This is because a user may wish to separate the strap from the housing of the electronics module, e.g., for strap replacement or to service to the electronics module. In all such instances, the attachment mechanism for connection between the strap and the electronics housing must be sufficiently resilient to withstand significant animal activity.

In some examples, the housing for an electronics module may be formed from a molded plastic and may have a defined pair of loops or a defined strap pathway that allows the strap portion of the animal collar to be fed therethrough to ensure it is securely retained on the strap. An example of a molded strap pathway is seen in U.S. Pat. No. 11,553,692, which shows a flexible strap positioned through a pathway formed in a molded electronics module, and passing over/adjacent to the electronics module as a continuous strap. Still further examples of mechanisms for attaching a strap to an electronics housing may include a permanent pin arrangement that retains a molded portion of a strap that may receive the pin through an aperture; an example of such an arrangement is seen in U.S. Pat. No. 7,426,906.

These existing strap retention mechanisms result in an often difficult or cumbersome replacement process. To replace a strap that uses a molded strap pathway, it may be required for a user to feed the strap back through the pathway and feed a new strap through the same pathway for replacement. To replace a strap that uses a pin and aperture arrangement, the user may need to remove the pin from the electronics housing to release the aperture. Use of the pin and aperture arrangement also risks loss of the pin.

In accordance with example embodiments discussed herein, the present disclosure relates to an animal collar that includes a novel connection mechanism for attaching and detaching the electronics module from a strap portion of the animal collar. The connection mechanism may be referred to as a connector. The connector can be a j-hook that attaches to one portion of the animal collar. In addition, the j-hook may connect to a pin that is attached to the electronics module to connect the strap portion of the collar to the electronics module. The j-hook may be constructed of a semi-rigid material, such as plastic, that enables the j-hook to disconnect by temporarily deforming to allow enough space for the j-hook to disconnect from the pin of the electronics module. The j-hook then returns to its original position. To reconnect, a similar process occurs except the pin fits within an aperture of the j-hook and is held within the aperture by an end of the j-hook since the opening is a smaller distance than the diameter of the pin. The j-hook is then connected to the pin of the electronics module.

Further, the animal collar may include two connectors for disconnecting the electronics module from two sections of the strap portion of the animal collar. For example, the electronics module may include two pins, one on each side of the housing of the electronics module. Each section of the strap portion of the animal collar also includes a respective j-hook that connects to the respective pin of the electronics module. Accordingly, the electronics module can be disconnected from both sections of the strap portion of the animal collar for easy repair or replacement.

Additional components can also be attached using the described connectors. While an electronics module is described, the connector may connect tags, trackers, or other components to the animal collar. In some embodiments, the j-hook connector attaches to a pin of different components that are interchangeable for attaching to the animal collar.

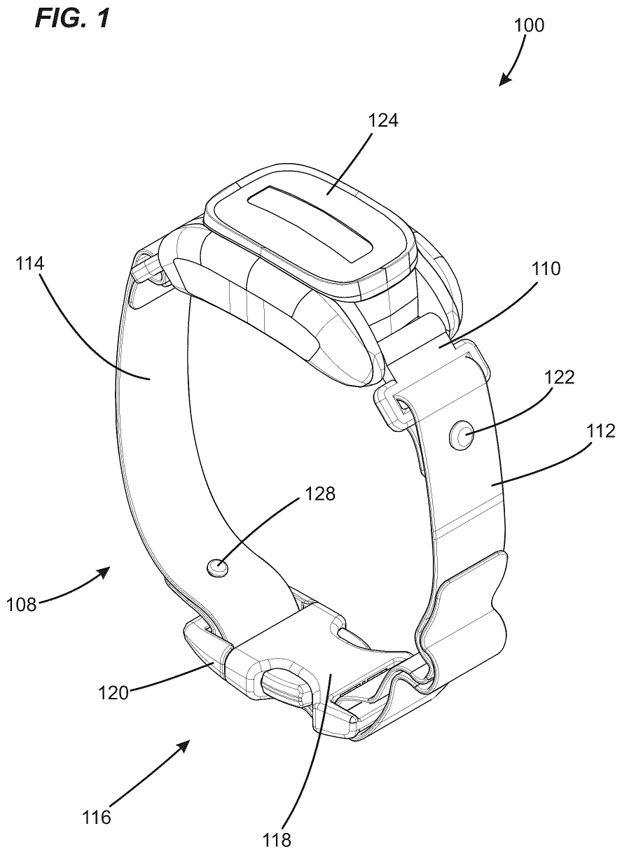

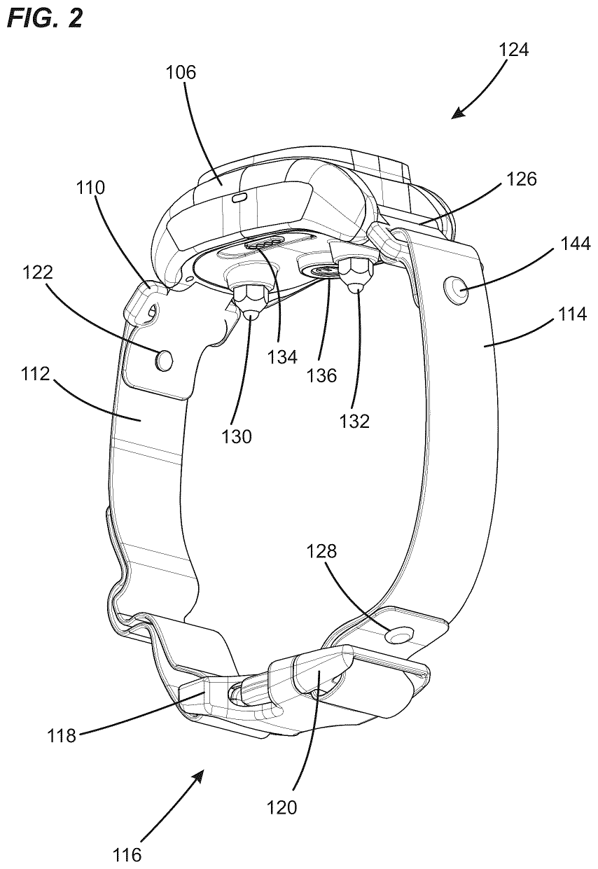

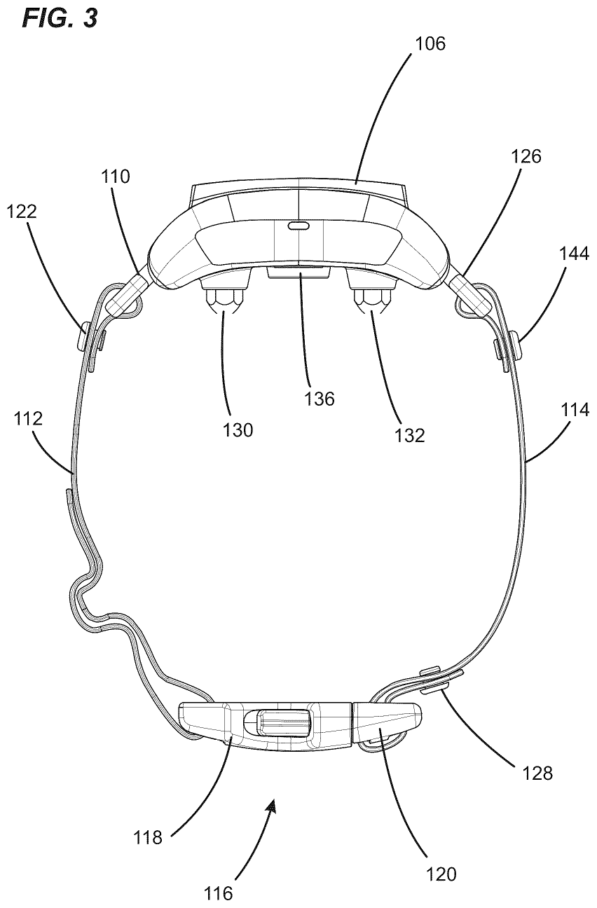

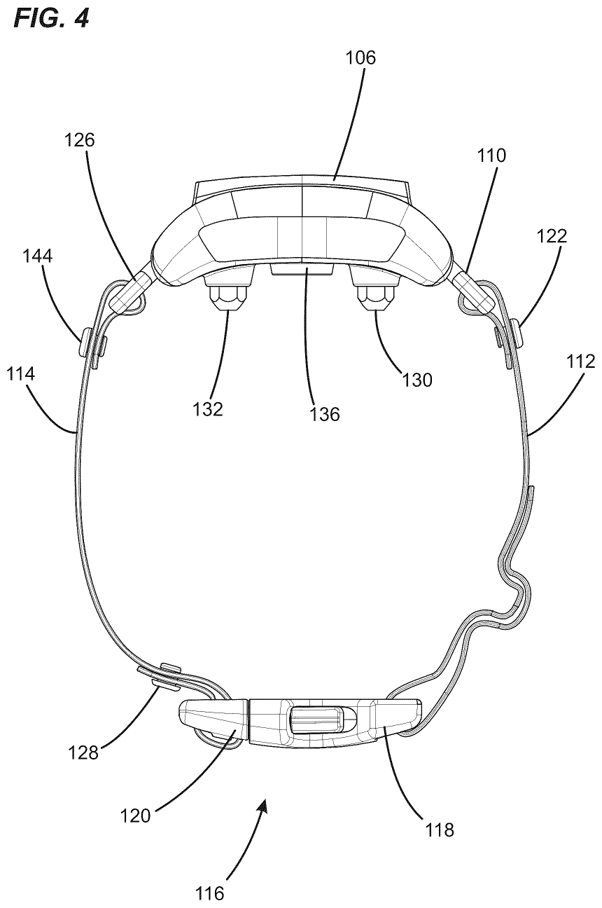

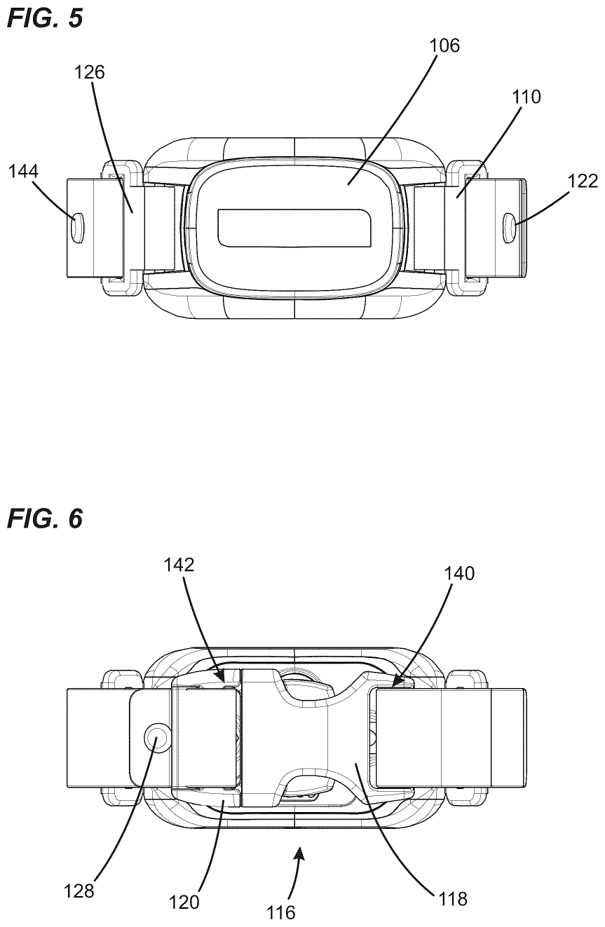

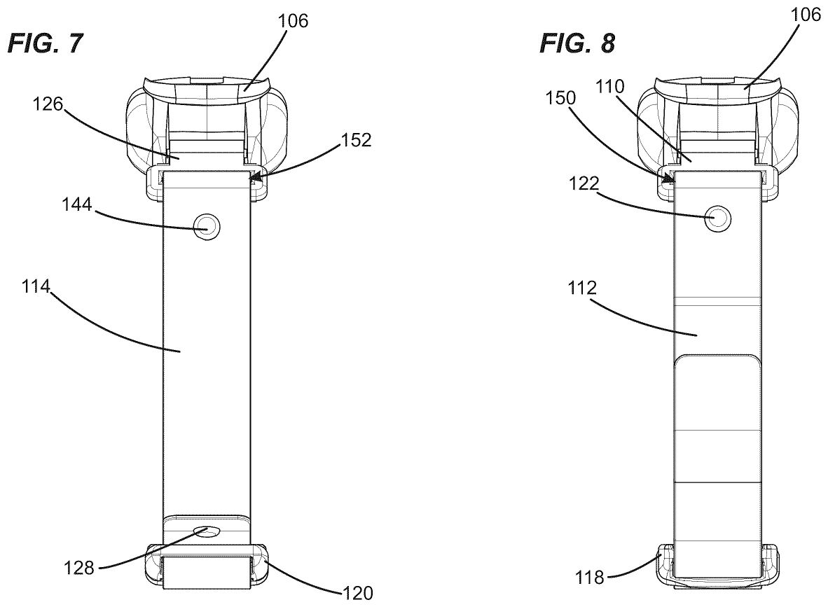

FIG. 1, FIG. 2, FIG. 3, FIG. 4, FIG. 5, FIG. 6, FIG. 7, and FIG. 8 illustrate an example collar 100 that includes a connector 110 and a connector 126 that are configured to connect to an electronics module 124. In the shown embodiment, the collar 100 includes a strap portion 108 with a first section 112 and a second section 114. The first section 112 includes a first end 118 of a buckle 116, and the second section 114 includes a second end 120 of the buckle 116. Further, the first section 112 includes a fastener 122, and the second section 114 includes a fastener 128 and a fastener 144. The electronics module 124 includes a housing 106. Further, the housing 106 includes a stimulus prong 130 and a stimulus prong 132 on a rear side of the housing 106. Also, the electronics module 124 includes an input 136 and a charging port 134 on the rear side of the housing 106.

The collar 100 is configured to be placed around an animal. For example, the collar can be placed around a neck of the animal by detaching the first end 118 of the buckle 116 from the second end 120. Then, the first section 112 and the second section 114 can be wrapped around opposite directions of the neck of the animal. The first end 118 and the second end 120 are then reattached, resulting in the collar 100 being attached to the animal. In some embodiments, the collar is attached with a similar process around a different body part of the animal, such as a leg.

The first section 112 and the second section 114 of the collar 100 form the strap portion 108 of the collar 100. In some embodiments, the strap portion 108 including the first section 112 and the second section 114 are made of a durable material that is comfortable and safe for the animal that wears the collar 100. The first section 112 and the second section 114 may be made of nylon, leather, polyester, cotton, neoprene, or other materials. Further, the first section 112 and the second section 114 may be waterproof and include a flexible material. The first section 112 and the second section 114 may be made of different materials or be the same material.

The buckle 116 attaches the first section 112 to the second section 114. In some embodiments, the buckle 116 is a snap buckle, frame buckle, plate buckle, pin buckle or some other kind of fastener. In some embodiments, the first end 118 of the buckle 116 includes an opening 140. In some embodiments, the first end 118 is a male end that includes a design with a flat, tapered section with two flexible prongs or tabs. These tabs are designed to click into place when inserted into the female end. In some embodiments, the second end 120 is a female end that houses the first end 118. The second end 120 includes mechanism to securely hold the male end prongs until they are pressed to release the connection.

In some embodiments, the first section 112 feeds through the opening 140 of the first end 118. Feeding some of the first section 112 attaches the first section 112 to the first end 118. More or less of the first section 112 can be fed the through the opening 140 to adjust the total circumference of the collar 100. This allows for the collar 100 to be attached to multiple different animal sizes. The second end 120 of the buckle 116 includes an opening 142. The second section 114 feeds through the opening 142 of the second end 120. The second section 114 is attached to itself using the fastener 128 after being fed through the opening 142 of the second end 120 to form a loop around a prong in the second end 120. As a result, the second section 114 is fixedly attached to the second end 120, that is the second section 114 is permanently attached to the second end 120 so that it cannot be removed without breaking or deforming the second section 114 or the second end 120. In some embodiments, the first section 112 is attached to itself using a fastener similarly to the second section 114. In some embodiments, the circumference of the collar is adjusted by feeding more or less of the second section 114 through the opening of the second end 120. The fastener 128 may be a rivet, nail, pin, adhesive, or other similar component. Further, the second section 114 may be sewn together once fed through the opening 142. In some embodiments, the first portion is sewn to itself once fed through the opening 140 resulting in the same permanent connection.

The electronics module 124 performs functions related to the animal, such as providing stimulus or tracking functions. Further, the electronics module 124 includes various components within the housing 106. In some embodiments, the electronics module 124 includes a transmitter, receiver, battery, and/or circuitry. The transmitter may transmit information, such as status information over cellular, Bluetooth, or Wi-Fi transmission technologies for tracking capabilities. In some embodiments, the transmitter transmits other data such as health data using other wireless communication methods. Further, the receiver may receive wireless communication signals. The receiver may receive Global Navigation Satellite System (GNSS) signals that are used to calculate a position of the collar 100. GNSS signals may include GPS, Galileo, GLONASS, BeiDou, AZSS, or IRNSS. The receiver may receive signals of the L1, L2, L3, L4, or L5 frequency bands. In some embodiments, the battery is replaceable or rechargeable.

In some embodiments, the circuitry of the electronics module 124 includes a processor and memory for processing stored instructions and performing various methods or functions, such as tracking or providing stimuluses under specified conditions. The processor may connect to the transmitter, receiver, and included battery. Further, the processor may connect to the stimulus prong 132 and the stimulus prong 130 to provide an electrical current as a stimulus to an animal that is wearing the collar 100. The stimulus helps obtain the attention of the animal. In some embodiments, the stimulus prong 130 and the stimulus prong 132 are electrodes.

The electronics module 124 also includes the input 136, which may control a power state of the electronics module 124. For example, the input 136 may be a button that can be pressed to turn the electronics module 124 to an on state or an off state. In some embodiments, the input 136 is a switch or other kind of input located anywhere on the housing 106. In the on state, the electronics module 124 may perform its programmed functions. The charging port 134 may be used to connect to an external power source to recharge the battery of the electronics module. In some embodiments, the charging port 134 is used to exchange data. For example, the charging port 134 may be used to update the firmware or other programmed software of the electronics module 124.

The first section 112 uses the connector 110 to connect to the electronics module 124, and the second section 114 uses the connector 126 to attach to connect to the electronics module 124, thus, attaching the electronics module 124 to the collar 100. In some embodiments, the first section 112 is fed through the opening 150 and attached to itself using the fastener 122. As a result, the first section 112 is fixedly attached to the connector 110. That is, the connector 110 is permanently attached to the first section 112 and cannot be removed without breaking or substantial alteration to the first section 112 or the connector 110. In some embodiments, the second section 114 is fed through the opening 152 and attached to itself using the fastener 144. As a result, the second section 114 is fixedly attached to the connector 126. That is, the connector 126 is permanently attached to the second section 114 similar to the first section 112 and the connector 110. In some embodiments, the fastener 122 and the fastener 144 may be a rivet, nail, pin, adhesive, or other similar component. In some embodiments, the first section 112 is sewn to itself after being fed through the opening 150 to attach to the connector 110. In some embodiments, the second section 114 is sewn to itself after being fed through the opening 152 to attach to the connector 126.

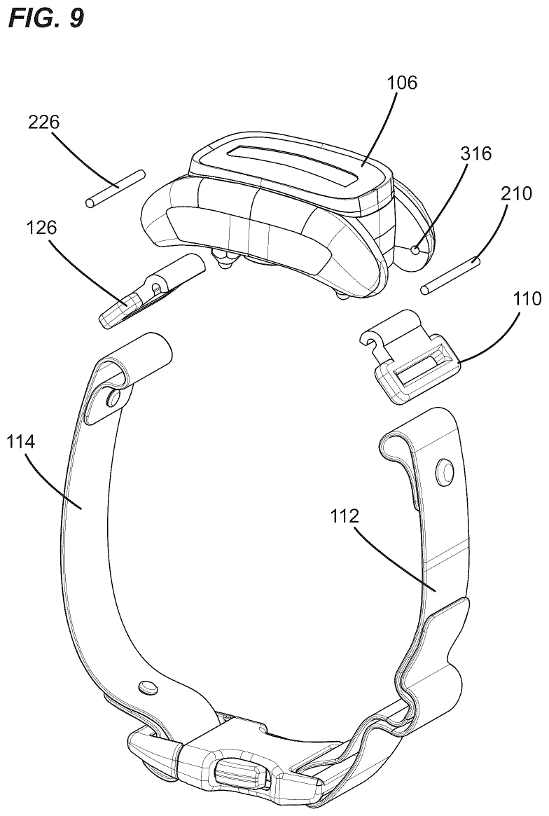

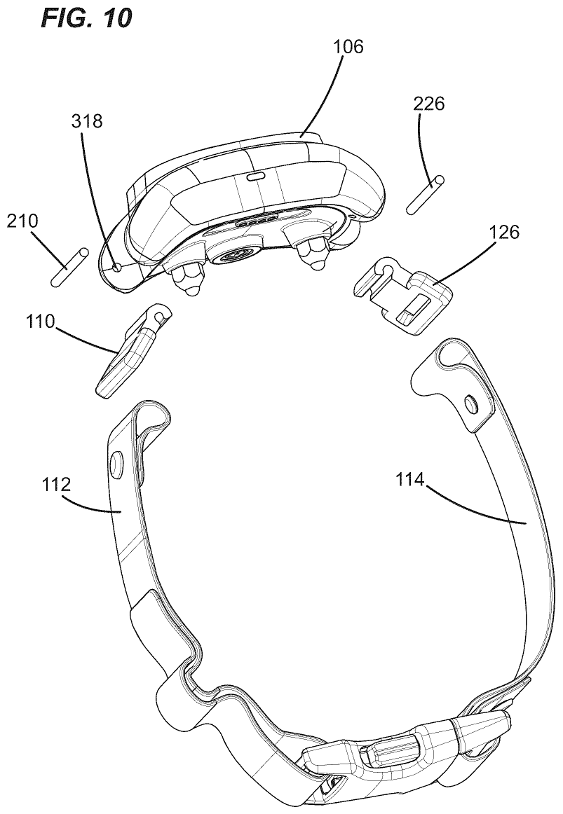

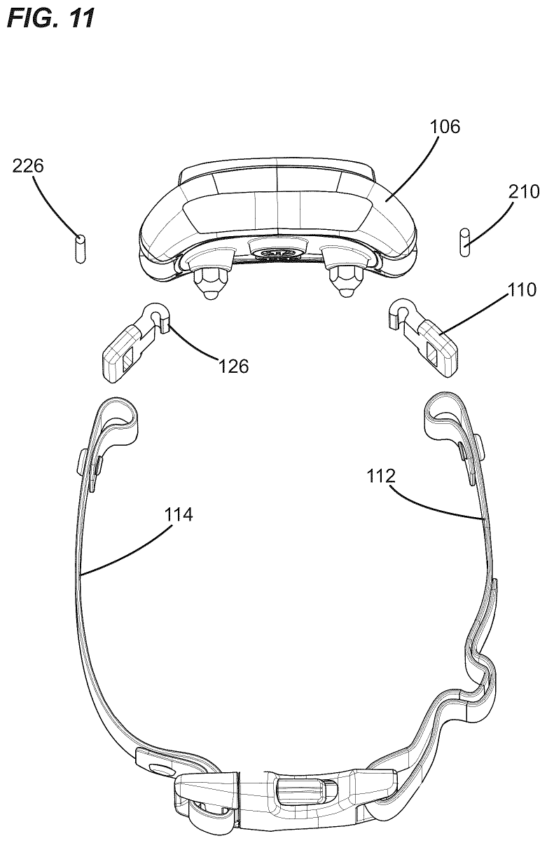

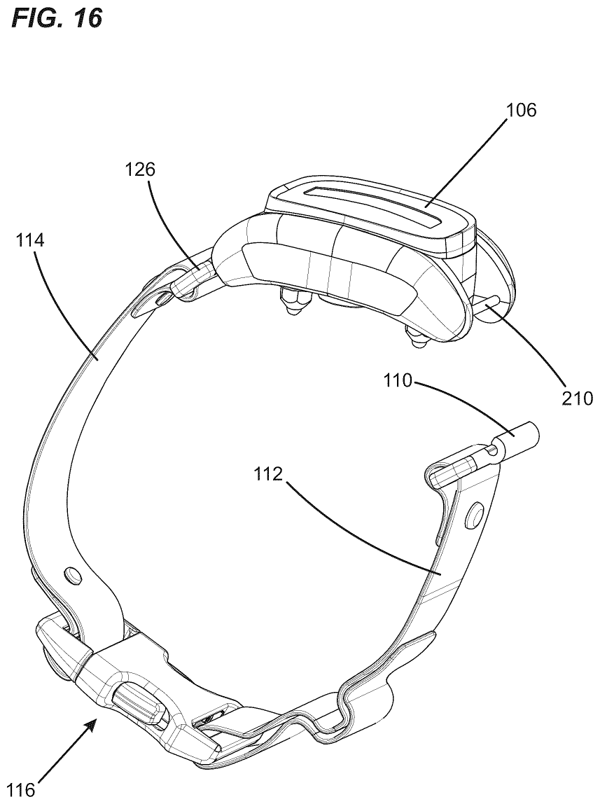

FIG. 9, FIG. 10, and FIG. 11 illustrate exploded views of the collar 100. The housing 106 further includes a pin 210 and a pin 226. The housing 106 includes an aperture 316 and an aperture 318 that include a diameter that is large enough to receive the pin 210. The pin 210 is cylindrical with a diameter D3 (shown in FIG. 15). In some embodiments, it is a different shape. The diameter of the aperture 316 and the aperture 318 is the same or larger than the diameter D3 of the pin 210. The pin 210 can then be fit into the aperture 316 and the aperture 318. In some embodiments, the pin 210 is permanently embedded within the aperture 316 and the aperture 318 and non-removable. Further, the housing 106 includes corresponding apertures (not shown) on the opposite side that also have a diameter large enough to receive the pin 226. These apertures are the same or similar to the aperture 316 and the aperture 318 and are designed to receive the pin 226 similarly to how the aperture 316 and the aperture 318 receive the pin 210. In some embodiments, the pin 210 and the pin 226 and the pin are constructed of a rigid material that does not deform. In some embodiments, the pin 210 and the pin 226 are made of metal or plastic. The pin 210 also includes the diameter D3 (shown in FIG. 15).

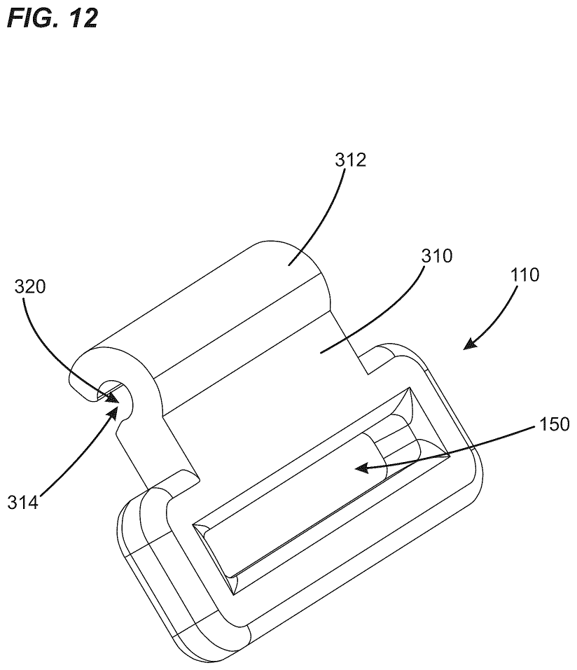

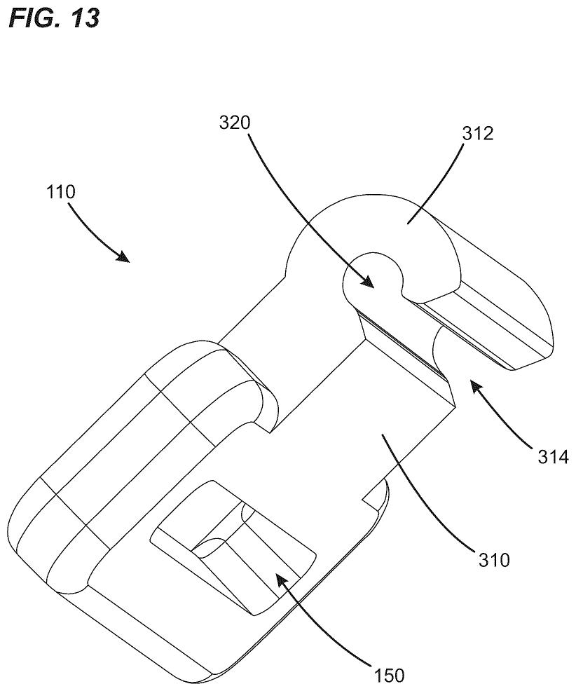

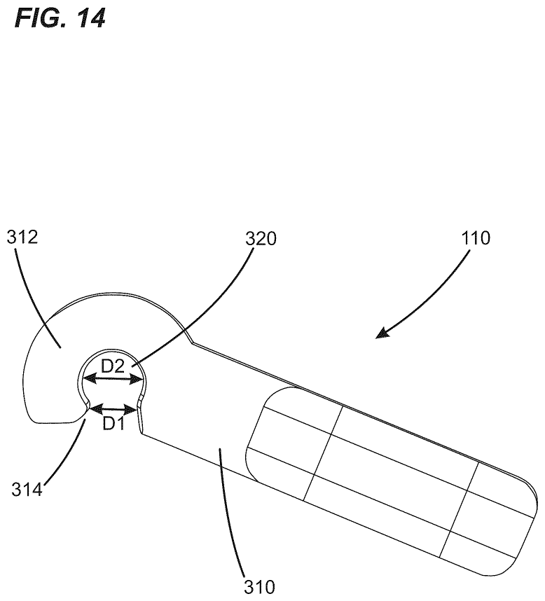

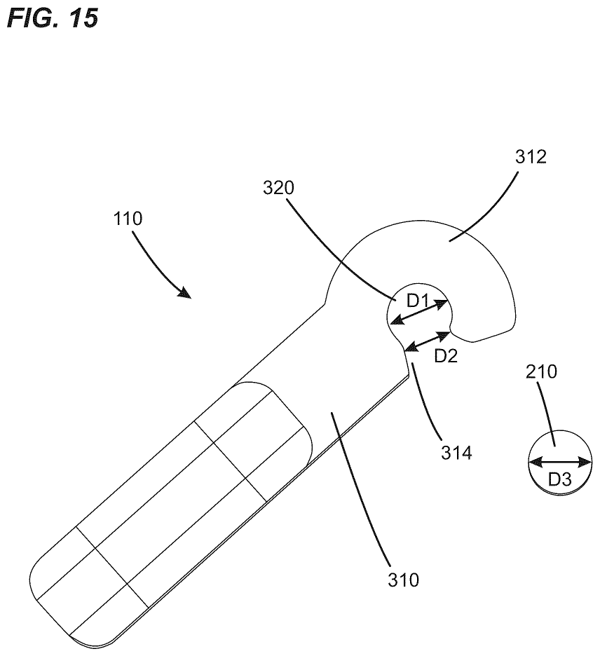

In the shown embodiment, the pin 210 fits within the opening of the hook 312 (shown in FIG. 12, FIG. 13, FIG. 14, and FIG. 15) of the connector 110. As a result, the first section 112 connects to the electronics module 124 through the connection of the connector 110 and the pin 210. Similarly, the second section 114 connects to the electronics module 124 through the connection of the connector 126 and the pin 226. In some embodiments, the pin 210 and the pin 226 can be replaced; in some implementations, pins 210, 226 are permanently embedded in housing 106. In some embodiments, the pin 210 and the pin 226 form a ring that can be hooked by the connector 110 and the connector 126, respectively.

FIG. 12, FIG. 13, FIG. 14, and FIG. 15 illustrate the connector 110. The connector 110 includes a frame 310, a hook 312, an opening 150, an opening 314, and a central aperture 320. Further, the opening 314 includes a distance D2 that measures between an end of the hook 312 and the frame 310. The central aperture 320 is cylindrical and includes a diameter D1.

The connector 110 and the connector 126 are configured to attach the strap portion 108 to the electronics module 124. In some embodiments, the connector 110 and the connector 126 are j-hooks. The connector 110 and the connector 126 include the hook 312 that catches another component so that the connector 110 and the connector 126 are connected or hooked to the other component. For example, the hook 312 may hook to the pin 210, rod, or other component that is configured to fit into the central aperture 320 of the hook 312. In some embodiments, the connector 110 is constructed of metal or plastic. In some embodiments, the hook 312 is made of a semi-rigid material that allows for temporary deformation or flexing of the hook 312. The material enables for the hook 312 to bend as it connects to another component. The connector 110 is deformable to allow the pin 210 to pass through the opening 314 with sufficient pressure, or force, on the hook 312 to cause the pin 210 to “snap” into place within the opening 314. The pressure required to deform the connector 110 to move the pin 210 in or out of the opening 314 is generally greater than forces experienced by the connector 110 through normal wear by the animal, thereby ensuring retention of the collar 100 on the animal during normal wear. The connector 126 is similarly designed.

For example, when pressure is applied to the connector 110, the hook 312 deforms to increase the distance D2 between an end of the hook 312 and the frame 310, such that when deformed, the distance D2 becomes larger than the diameter D3. The diameter D1 is the same or larger than the diameter D3. As such, while the hook 312 is bent and the distance D2 increased, the pin 210 can pass through the opening 314 and rest within the central aperture 320. The hook 312, being a resilient component, returns to its original shape, thereby decreasing the distance D2 back to its normal range, which is less than the diameter D3. The pin 210 therefore cannot exit back through the opening 314 since the distance D2 is less than the diameter D3 of the pin 210. To remove the pin 210, a user must apply sufficient force to the hook 312, to again deform the connector 110 and increase the distance of D2 to a length larger than the diameter D3. The pin 210 can pass through the opening 314 to exit the central aperture 320. This process facilitates the “snap” connection of the strap portion 108 from the housing 106 of the electronics module if the pin is secured within the aperture 316 and the aperture 318, the connector 110 is secured to the first section 112, and the connector 126 is secured to the second section 114. In some embodiments, the distance D1 is 2 mm or greater. In some embodiments, the diameter D3 is less than 2 mm, for example in the range of 1.5 to 1.95 mm. In some embodiments, the distance D3 is 2 mm.

The frame 310 provides the structure that connects the hook 312 to the opening 152 so the connector 110 can attach two different devices, such as the first section 112 to the electronics module 124. Further, the frame 310 forms the opening 150 to allow a component, such as the first section 112, to be fed through the opening 150 and attach to the connector 110. In some embodiments, the frame 310 includes another mechanism for connecting to other components. For example, the frame 310 may include a second hook for connecting to other components. In some embodiments, the frame 310 may connect to other components in other ways, such as by using a fastener. Further, the connector 126 may include the same or similar hook 312 and frame 310 and constructed in the same or similar way as the connector 110. In some embodiments, the connector 126 includes a similar design to the connector 110 to facilitate the same process of connecting to the pin 226. In some embodiments, the connector 126 includes a different design with different materials.

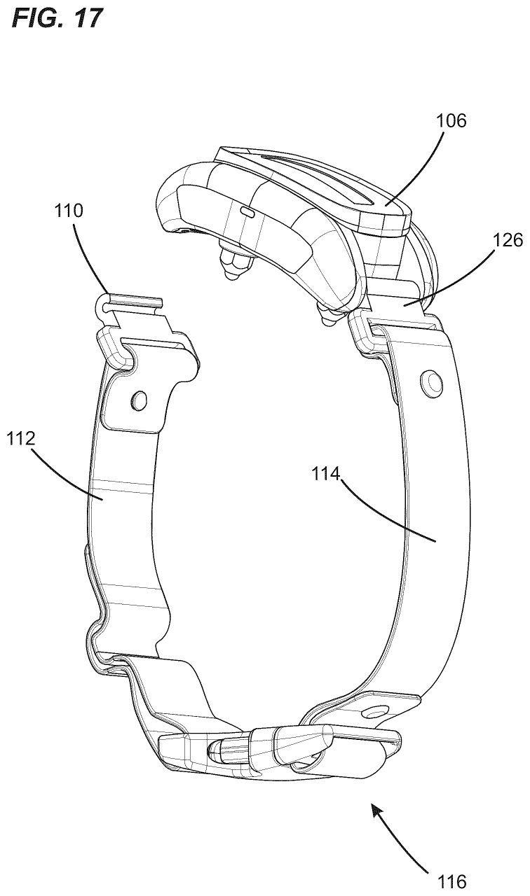

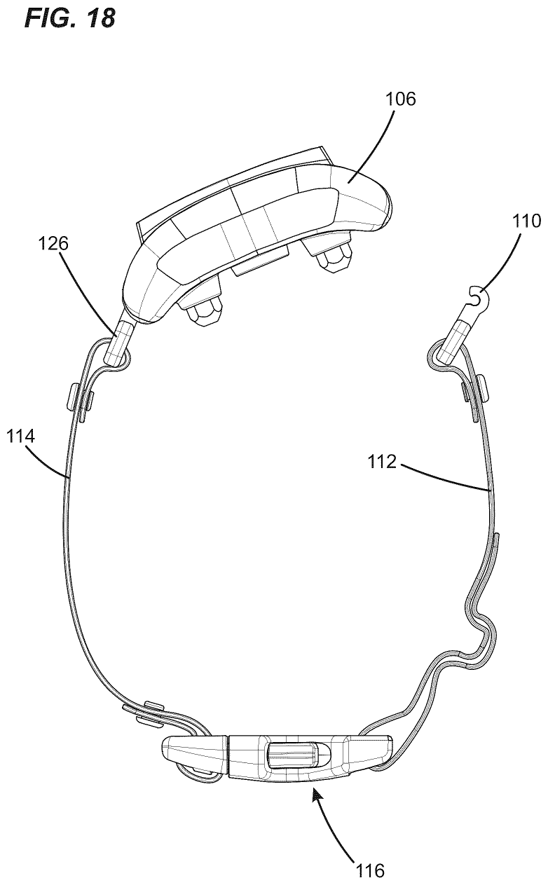

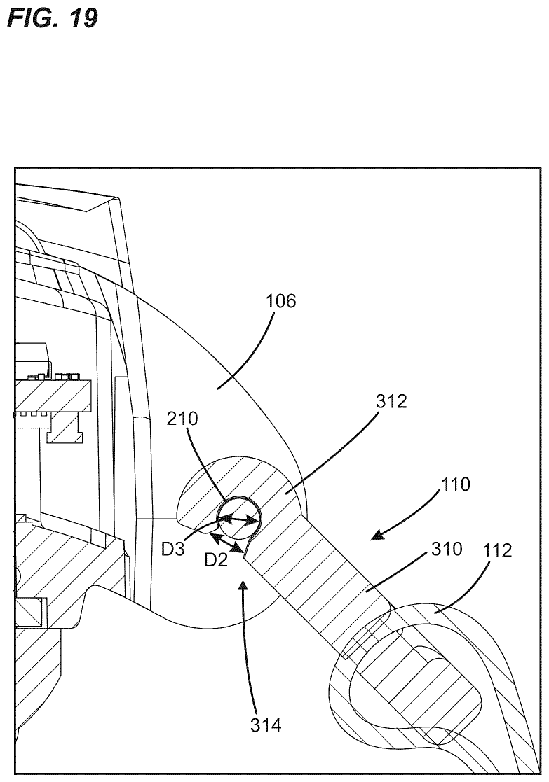

FIG. 16, FIG. 17, and FIG. 18 illustrate the connector 110 disconnected from the electronics module 124 of the collar 100. The electronics module 124 can be disconnected from the first section 112 using the process described above to expand the distance D2 to be larger than the diameter D3. The same or similar process is also used to disconnect the connector 126 from the pin 226 so the second section 114 is disconnected from the electronics module 124. The electronics module can then be more easily examined, repaired, replaced, or have its battery replaced without the remaining components of the collar 100 being in the way.

In some embodiments, the connector 110 is configured to pivot around the loop of the first section 112. The connector 110 can be rotated around the loop of the first section 112 that is formed from feeding the first section 112 through the opening 150. Accordingly, the connector 110 can be placed in different positions relative to the first section 112 and the electronics module 124. The connector 126 performs the same feature and can pivot around the loop of the second section 114 that forms from feeding the second section 114 through the opening 152.

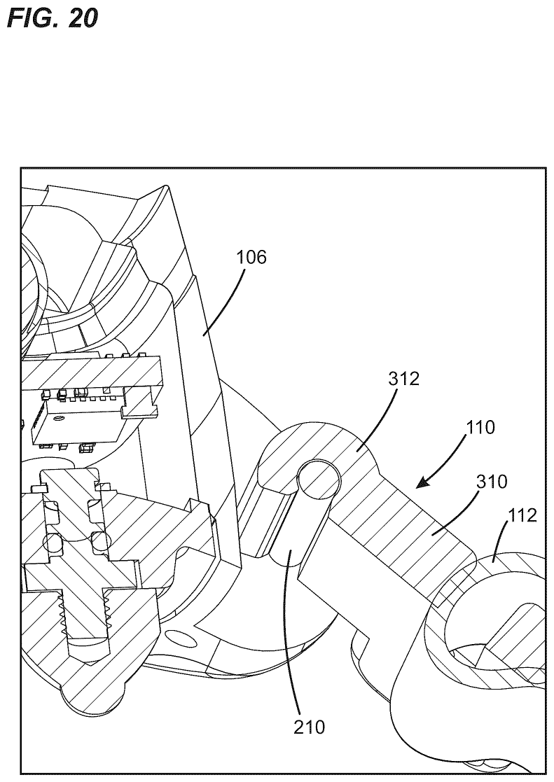

FIG. 19 and FIG. 20 illustrate cross-sectional views of the connector 110 in a connected position to the electronics module 124. In the shown embodiment, the hook 312 of the connector 110 hooks the pin 210 so that the pin 210 is within the central aperture 320 of the hook 312. As previously mentioned, the hook 312 may be made of a semi-rigid material, such as a molded plastic, that deforms or flexes to fit the pin 210 within the opening 314 and rest the pin 210 within the central aperture 320. Once fit within the opening 314, the distance D2 is smaller than the diameter D3 to prevent disconnection without a strong force to snap the hook 312 from the pin 210. The pin 210 cannot fit through the opening 314 because the diameter D3 is greater in length than the distance D2 when the hook 312 is in a non-deformed position.

Further, the first section 112 forms the shown loop by being fed through the opening 150 of the connector 110. The first section 112 can adjust or flex while the connector 110 is connected to the pin 210 since the first portion can slide back and forth through the opening 150. In some embodiments, the second section 114, the connector 126, and the pin 226 form a similar connection as shown in FIG. 19 and FIG. 20.

In some embodiments, the pin is permanently fixed within the aperture 316 and the aperture 318 as previously described. The strap portion 108 can then be replaced by disconnecting the connector 110 and the connector 126. Another strap portion with the same components can then be connected. Based on the pin 210 and the pin 226 being permanently fixed to the housing 106, the connector 110 being permanently fixed to the first section 112 of the strap portion 108, and the connector 126 being permanently fixed to the second section 114 of the strap portion 108, the connection of the connector 110 to the pin 210 and the connection of the connector 126 to the pin 226 facilitates the attachment and detachment of the electronics module 124 from the strap portion 108. This provides a resilient connection mechanism when worn by the animal, while enabling a user to conveniently detach and reattach different strap portions to the electronics module 124. So, the same electronics module 124 may be used with different straps with the same components as the strap portion 108 as the straps wear. In some embodiments, the strap portion 108 does not extend along the housing 106 adjacent to the housing 106. In some embodiments, the strap portion 108 does not pass through loops of the housing 106 to secure the electronics module 124 to the strap portion 108.

While shown with an electronics module 124, some embodiments use the connector 110 and the connector 126 to connect the first section 112 and the second section 114 to a third portion of the collar 100. The third portion may be a tag, an additional electronics module, a tracking device, an antenna, accessories, training aids, lights, reflectors, or a leash.

In an example, an animal collar includes an electronics module including a housing having a first side end and an opposed second side end. The housing includes a first pin extending along the first side and a second pin extending along the second side. The first pin and the second pin are each cylindrical-shaped and have a diameter. The animal collar further includes a strap portion having a first flexible section and a second flexible section. The first flexible section and the second flexible section are attachable to each other at a buckle. The animal collar further includes a first j-hook fixedly attached at an opposite end of the first flexible section from the buckle and a second j-hook fixedly attached at an opposite end of the second flexible section from the buckle. The first j-hook and the second j-hook each are constructed from a resilient material and have an opening and a central aperture. The opening leads to the central aperture. The central aperture has a diameter sized to accommodate the diameter of the first pin or the second pin, and the opening has a distance smaller than the diameter of the first pin or the second pin.

In some examples, the first pin and the second pin each are embedded in the housing and non-removable from the housing of the electronics module. In some examples, the first pin extends along the first side and is generally parallel with the first side end, and the second pin extends along the second side and is generally parallel with the second side end. In some examples, the first j-hook and the second j-hook are constructed of a plastic material selected to deform to allow passage of the first pin or the second pin through the opening and into the central aperture. In some examples, the buckle is a plastic buckle clip. In some examples, the first flexible section and the second flexible section are constructed from a fabric or nylon material. In some examples, the first flexible section is fixedly attached to the first j-hook, and the second flexible section is fixedly attached to the second j-hook. In some examples, the electronics module includes at least one stimulus contact on a rear side of the housing. In some examples, when the first j-hook is attached to the first pin and the second j-hook is attached to the second pin, the strap portion does not extend along the housing adjacent to the housing. In some examples, the diameter is generally 2 mm.

In an additional example, a replacement strap for an animal collar includes a strap portion having a first flexible section and a second flexible section. The first flexible section and the second flexible section are attachable to each other at a buckle. The replacement strap further includes a j-hook fixedly attached at an opposite end of the first flexible section from the buckle. The j-hook is constructed from a resilient material and has an opening and a central aperture. The opening leads to the central aperture. The central aperture of the j-hook has a diameter sized to accommodate a cylindrical pin of a housing to which the replacement strap is attachable, and the opening has a distance smaller than the diameter of the cylindrical pin.

In some examples, the replacement strap further includes a second j-hook fixedly attached at an opposite end of the second flexible section from the buckle. In some examples, the diameter of the j-hook is selected such that, when the j-hook is attached to the cylindrical pin, the j-hook is pivotable around a central axis of cylindrical pin. In some examples, the j-hook is constructed of a plastic material selected to deform to allow passage of a pin through the opening and into the central aperture. In some examples, the buckle is a plastic buckle clip. In some examples, the strap portion is constructed from a fabric or nylon material. In some examples, the opening has a distance of less than 2 mm.

In an additional example, an animal collar includes a component having a first side end and an opposed second side end. The component includes a first pin extending along the first side and a second pin extending along the second side. The first pin and the second pin are each cylindrical-shaped and having a diameter. The animal collar further includes a strap portion having a first flexible section and a second flexible section. The first flexible section and the second flexible section are attachable to each other at a buckle. The animal collar further includes a j-hook fixedly attached at an opposite end of the first flexible section from the buckle. The j-hook is constructed from a resilient material and has an opening and a central aperture. The opening leads to the central aperture. The central aperture of the j-hook has a diameter sized to accommodate the first pin to which the replacement strap is attachable, and the opening has a distance smaller than the diameter of the first pin.

In some examples, the first pin and the second pin each are embedded in the component and non-removable from the component. In some examples, the first pin extends along the first side end and is generally parallel with the first side end, and the second pin extends along the second side end and is generally parallel with the second side end. In some examples, the animal collar further includes a second j-hook fixedly attached at an opposite end of the second flexible section from the buckle. The j-hook is constructed from a resilient material and has a second opening and a second central aperture. The second opening leads to the second central aperture, and the second central aperture of the second j-hook has a diameter sized to accommodate the second pin. The second opening has a distance smaller than the diameter of the second pin.

Referring to FIGS. 1-20 generally, it can be seen that the attachment mechanism described herein has a number of advantages in terms of resilience and user flexibility. For example, the attachment mechanism as described a provides a resilient connection mechanism when worn by the animal, while enabling a user to conveniently detach and reattach different strap portions to the electronics module. So, the same electronics module may be used with different straps as wear is experienced on the flexible strap portion. Other advantages are provided as well, as are reflected above and embodied in the following claims.

The present disclosure is not to be limited in terms of the particular embodiments described in this application, which are intended as illustrations of various aspects. Many modifications and variations can be made without departing from its spirit and scope. Functionally equivalent methods and systems within the scope of the disclosure, in addition to those enumerated herein, are possible from the foregoing descriptions. Such modifications and variations are intended to fall within the scope of the appended claims. The terminology used herein is for the purpose of describing particular embodiments only, and is not intended to be limiting.

1. An animal collar comprising:
an electronics module including a housing having a first side end and an opposed second side end, the housing including a first pin extending along the first side and a second pin extending along the second side, the first pin and the second pin each being cylindrical-shaped and having a diameter;
a strap portion having a first flexible section and a second flexible section, the first flexible section and the second flexible section attachable to each other at a buckle;
a first connector that forms a first hook fixedly attached at an opposite end of the first flexible section from the buckle;
a second connector that forms a second hook fixedly attached at an opposite end of the second flexible section from the buckle;
wherein:
the first hook and the second hook each are constructed from a resilient material and each having an opening and a central aperture, the opening leading to the central aperture,
the central aperture has a diameter sized to accommodate the diameter of the first pin or the second pin, and wherein the opening has a distance smaller than the diameter of the first pin or the second pin;
wherein the first connector and the second connector each also form a second opening and a third opening, respectively, for the first flexible section and the second flexible section respectively to be fed through to fixedly attach; and
the first connector is a single structure including the first hook and the second opening and the second connector is a single structure including the second hook and the third opening.

2. The animal collar of claim 1, wherein the first pin and the second pin each are embedded in the housing and non-removable from the housing of the electronics module.

3. The animal collar of claim 1, wherein the first pin extends along the first side and is parallel with the first side end, and the second pin extends along the second side and is parallel with the second side end.

4. The animal collar of claim 1, wherein the first hook and the second hook are constructed of a plastic material selected to deform to allow passage of the first pin or the second pin through the opening and into the central aperture.

5. The animal collar of claim 1, wherein the buckle is a plastic buckle clip.

6. The animal collar of claim 1, wherein the first flexible section and the second flexible section are constructed from a fabric or nylon material.

7. The animal collar of claim 1, wherein the first flexible section is fixedly attached to the first hook, and the second flexible section is fixedly attached to the second hook.

8. The animal collar of claim 1, wherein the electronics module includes at least one stimulus contact on a rear side of the housing.

9. The animal collar of claim 1, when the first hook is attached to the first pin and the second hook is attached to the second pin, the strap portion does not extend along the housing adjacent to the housing.

10. The animal collar of claim 1, wherein the diameter of the central aperture is greater than 1.95 mm.

11. A replacement strap for an animal collar comprising:
a strap portion having a first flexible section and a second flexible section, the first flexible section and the second flexible section attachable to each other at a buckle; and
a connector fixedly attached at an opposite end of the first flexible section from the buckle, the connector including a hook and being constructed from a resilient material and having an opening and a central aperture, the opening leading to the central aperture,
wherein the central aperture of the hook has a diameter sized to accommodate a cylindrical pin of a housing to which the replacement strap is attachable, and wherein the opening has a distance smaller than the diameter of the cylindrical pin; and
wherein the hook includes a second opening for the first flexible section to be fed through to fixedly attach, and the connector is a single structure including the hook and the second opening.

12. The replacement strap of claim 11, wherein the replacement strap further includes a second hook fixedly attached at an opposite end of the second flexible section from the buckle.

13. The replacement strap of claim 11, wherein the diameter of the hook is selected such that, when the hook is attached to the cylindrical pin, the hook is pivotable around a central axis of cylindrical pin.

14. The replacement strap of claim 11, wherein the hook is constructed of a plastic material selected to deform to allow passage of a pin through the opening and into the central aperture.

15. The replacement strap of claim 11, wherein the buckle is a plastic buckle clip.

16. The replacement strap of claim 11, wherein the strap portion is constructed from a fabric or nylon material.

17. The replacement strap of claim 11, wherein the opening has a distance of less than 2 mm.

18. An animal collar, comprising:
a component having a first side end and an opposed second side end, the component including a first pin extending along the first side and a second pin extending along the second side, the first pin and the second pin each being cylindrical-shaped and having a diameter;
a strap portion having a first flexible section and a second flexible section, the first flexible section and the second flexible section attachable to each other at a buckle; and
a connector fixedly attached at an opposite end of the first flexible section from the buckle, the connector including a hook and being constructed from a resilient material and having an opening and a central aperture, the opening leading to the central aperture,
wherein the central aperture of the hook has a diameter sized to accommodate the first pin to which the strap portion is attachable, and wherein the opening has a distance smaller than the diameter of the first pin; and
wherein the connector includes a second opening for the first flexible section to be fed through to fixedly attach, and the connector is a single structure including the hook and the second opening.

19. The animal collar of claim 18, wherein the first pin and the second pin each are embedded in the component and non-removable from the component.

20. The animal collar of claim 19, wherein:
the first pin extends along the first side end and is parallel with the first side end, and the second pin extends along the second side end and is parallel with the second side end,
the animal collar further includes a second hook fixedly attached at an opposite end of the second flexible section from the buckle, the hook being constructed from the resilient material and having a third opening and a second central aperture, the third opening leading to the second central aperture, and
the second central aperture of the second hook has a diameter sized to accommodate the second pin, and wherein the third opening has a distance smaller than the diameter of the second pin.
